(19) United States
(12) Patent Application Publication
(10) Pub. No.: US 2021/0184355 A1
(43) Pub. Date: Jun. 17, 2021

(54) TOROIDALLY-WOUND TOROIDAL WINDING ANTENNA FOR HIGH-FREQUENCY APPLICATIONS

(71) Applicant: HALLIBURTON ENERGY SERVICES, INC., Houston, TX (US)

(72) Inventors: Burkay DONDERICI, Houston, TX (US); Baris GUNER, Houston, TX (US)

(21) Appl. No.: 16/077,485

(22) PCT Filed: Jun. 27, 2017
(86) PCT No.: PCT/US2017/039493

§ 371 Date: Aug. 13, 2018

(51) Int. Cl. H01Q 7/06; H01Q 1/04; H01Q 11/08

(52) U.S. Cl. CPC H01Q 7/06; H01Q 11/08; H01Q 1/04

(57) ABSTRACT

A sensor and sensing method for a downhole logging tool provide an antenna having a toroidal or spiral winding that is toroidally or helically wound around a toroid core. The toroidally-wound toroidal winding antenna forms a natural high-pass filter that is capable of suppressing low-frequency and midrange frequency noise and other interference. This allows the logging tool to sense or detect high-frequency signals, or the high-frequency component of a signal, more clearly and accurately. Multiple toroidally-wound toroidal winding antennas may be used in multiple different configurations, including a multi-axial configuration, bucking configuration, radial configuration, and the like. The sensor and sensing method are particularly useful in applications, such as dielectric logging, short hop communications, waterflood monitoring, and the like.

### TECHNICAL FIELD

The exemplary embodiments disclosed herein relate generally to sensors used for measuring formation properties and, more specifically, to sensors and sensing methods that employ antennas having toroidally-wound toroidal windings (TWTW) to make high-frequency measurements.

### BACKGROUND

Formation properties such as resistivity and permittivity are used in the oil and gas industry to assess the likelihood that hydrocarbon may be present in a subterranean formation. Electromagnetic logging tools are available that can estimate the resistivity and permittivity of a volume of interest in the formation. These logging tools typically operate by causing an electromagnetic wave to propagate from a wellbore into the formation. The logging tools often employ a sensor in the form of an antenna to receive electromagnetic waves returning from the formation. The received electromagnetic waves induce voltages in the antenna that may be logged (i.e., recorded) and processed to obtain an estimation of the resistivity, permittivity, and other properties of the volume being investigated.

One type of antenna often used with electromagnetic logging tools is a toroid antenna. A toroid antenna is essentially a wire wound in a helical pattern around a core having the shape of a toroid (i.e., a surface of revolution obtained by revolving a circle around a central axis). The toroid core is typically made of a ferromagnetic material, such as iron, steel, cobalt, nickel, and the like, that is insulated from the wire. The toroid antenna is typically mounted coaxially on a section of tubing or pipe, such as a mandrel of the logging tool or a drill collar (e.g., within an annular recess thereof). A single toroid antenna may be used as both transmitter and receiver antenna in some applications, or multiple toroid antennas may be used as transmitter and/or receiver antennas in some applications. It is also possible to use a combination of toroidal antennas and non-toroidal antennas in some applications.

However, while existing toroid antennas have generally been satisfactory as sensors in downhole logging tools, these toroid antennas can be somewhat sensitive to low-frequency and midrange frequency noise and other interference, either from other downhole logging tools operating in the wellbore and/or from the subterranean formation at large. Thus, there continues to be a need for an improved antenna that may be used as a sensor in downhole logging applications.

### BRIEF DESCRIPTION OF THE DRAWINGS

For a more complete understanding of the exemplary disclosed embodiments, and for further advantages thereof, reference is now made to the following description taken in conjunction with the accompanying drawings in which:

FIG. 1A illustrates an exemplary well in which a toroidally-wound toroidal winding antenna may be used according to the disclosed embodiments;

FIG. 1B illustrates another exemplary well in which a toroidally-wound toroidal winding antenna may be used according to the disclosed embodiments;

FIG. 2 illustrates an exemplary formation evaluation system that may be used with a toroidally-wound toroidal winding antenna;

FIG. 3 illustrates an exemplary toroidally-wound toroidal winding antenna according to the disclosed embodiments;

FIG. 4 illustrates an exemplary toroidally-wound toroidal winding antenna according to the disclosed embodiments;

FIG. 5 illustrates another exemplary toroidally-wound toroidal winding antenna according to the disclosed embodiments;

FIG. 6 illustrates electric and magnetic fields for an exemplary toroidally-wound toroidal winding antenna according to the disclosed embodiments;

FIG. 7 illustrates an exemplary multi-axial configuration of toroidally-wound toroidal winding antennas according to the disclosed embodiments;

FIG. 8 illustrates an exemplary bucking configuration of toroidally-wound toroidal winding antennas according to the disclosed embodiments;

FIG. 9 illustrates an exemplary radial configuration of toroidally-wound toroidal winding antennas according to the disclosed embodiments;

FIG. 10 illustrates a method of designing an exemplary toroidally-wound toroidal winding antenna according to the disclosed embodiments;

FIG. 11 illustrates an exemplary frequency response of a toroidally-wound toroidal winding antenna according to the disclosed embodiments; and

FIG. 12 illustrates another exemplary frequency response of a toroidally-wound toroidal winding antenna according to the disclosed embodiments.

### DESCRIPTION OF EXEMPLARY EMBODIMENTS

The following discussion is presented to enable a person skilled in the art to make and use the exemplary disclosed embodiments. Various modifications will be readily apparent to those skilled in the art, and the general principles described herein may be applied to embodiments and applications other than those detailed below without departing from the spirit and scope of the disclosed embodiments as defined herein. Accordingly, the disclosed embodiments are not intended to be limited to the particular embodiments shown, but are to be accorded the widest scope consistent with the principles and features disclosed herein.

The embodiments disclosed herein relate to improved sensors and sensing methods for use in evaluating the resistivity and permittivity of a subterranean formation. The disclosed sensors and sensing methods advantageously employ antennas having toroidally-wound toroidal windings (“TWTW”) to make high-frequency measurements. The TWTW antennas are able to act as natural high-pass filters to suppress low-frequency and midrange frequency noise and other interference. Such antennas allow a logging tool to sense or detect high-frequency signals, or the high-frequency component of a signal, more clearly and accurately. Multiple TWTW antennas may be used in multiple different configurations, including a multi-axial configuration, bucking configuration, radial configuration, and the like. The TWTW antennas are particularly useful in applications like dielectric logging (including logging/measurement while drilling (L/MWD) operations), short hop communications, waterflood monitoring, and the like.

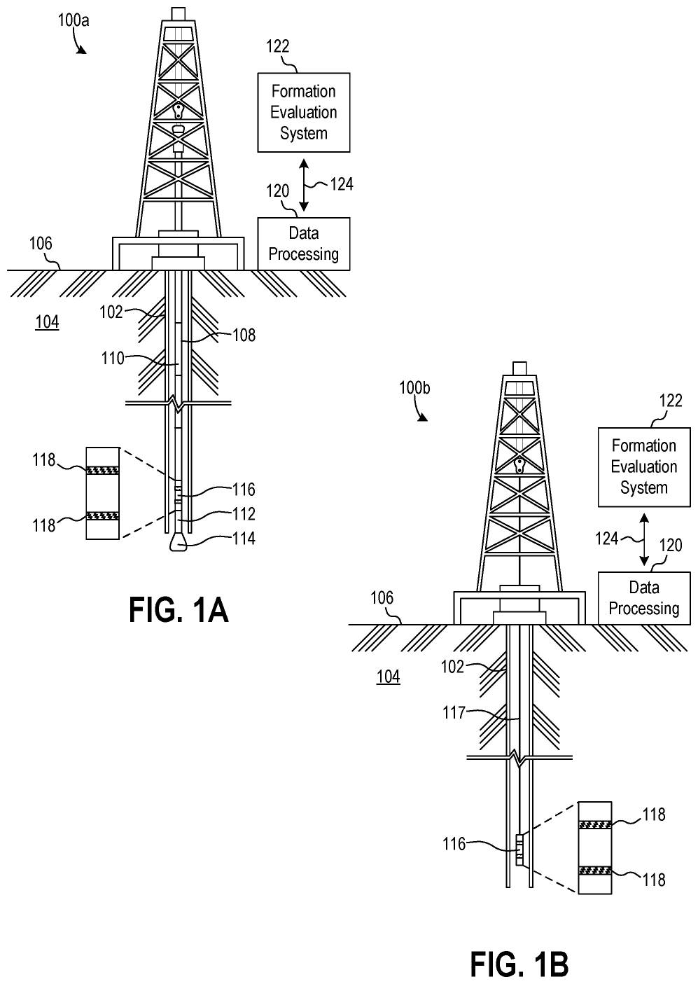

Referring now to FIG. 1A, a drilling rig 100a is shown in which the sensors and sensing methods disclosed herein may be used to determine formation resistivity, permittivity, and other formation properties. The drilling rig 100a is located above a borehole 102 that has been drilled through a subterranean formation 104 from a surface location 106. The surface location 106 is depicted here as an onshore location, but may also be an offshore location or any other location from which the borehole 102 may be drilled. A drill string 108 composed of a continuous length of assembled pipe segments 110 is suspended from the drilling rig 100a. The drill string 108 typically has a bottom-hole-assembly (BHA) attached at the end thereof that includes a rotary drilling motor 112 connected to a drill bit 114. A non-exclusive list of BHA components includes: drill pipe, drill collars, agitators, exciters, jars, stabilizers, reamers, hole openers, filter subs, circulation subs, monel or non-magnetic drill collars, crossovers, mud motor, the aforementioned drill bit, and the like. The drill string 108 may further include a downhole tool 116, such as a logging/measurement while drilling (L/MWD) tool, that can be used to assess formation resistivity and other formation properties.

Other conveyances in addition to the drill string 108 may also be used to convey the downhole tool 116, as depicted in the drilling rig 100b of FIG. 1B. These conveyances may include, for example, a wireline, slickline, coiled tubing, pipe, tractor, and the like, including conveyances that comprise a conductor where tool measurements may be conveyed to the surface by telemetry along the conveyance, as well as conveyances that do not comprise a conductor. In the latter case, tool measurements may be transmitted to the surface acoustically, electromagnetically, or via mud pulse telemetry, or stored in memory and subsequently retrieved at the surface. In the example of FIG. 1B, a wireline 117 is used as the conveyance for the downhole tool 116.

In accordance with the disclosed embodiments, one or more TWTW antenna sensors 118 are mounted on the downhole tool 116, for example, on a mandrel of the logging tool 116 (e.g., within an annular recess thereof). These TWTW antenna sensors 118 receive electromagnetic waves returning from the formation, allowing them to be logged as voltages by the downhole tool 116. The recorded voltages are then communicated, typically in real time, to a data processing unit 120 located either near the drilling rig 100a, 100b and/or at another location where they are processed (e.g., filtering, analog-to-digital conversion, etc.) as needed. It is also possible to locate the data processing unit 120 downhole on the drill string 108, for example, in the logging tool 116, for in-situ processing of the sensor data from the sensors 118. Alternatively, a portion of the data processing unit 120 may be located downhole and a portion located on the surface as needed to optimize processing of the sensor data. The data processing unit 120 thereafter sends the processed data to a formation evaluation system 122 via a communication link 124 to derive an estimation of the formation resistivity, permittivity, and other properties of the formation.

In the embodiment of FIGS. 1A and 1B, the one or more TWTW antenna sensors 118 are shown as coaxially mounted on the downhole tool 116. Other embodiments may employ alternative arrangements, such as a radial mounting configuration, without departing from the scope of the disclosed embodiments. A conventional antenna (not expressly shown) may be used in some embodiments to transmit the electromagnetic waves into the formation 104, or one or more of the TWTW antenna sensors 118 may be used as both a transmitter and a receiver in some embodiments. Single-sensor embodiments as well as embodiments that use multiple sensors 118 are contemplated. It is also possible to use a combination of TWTW antenna sensors 118 and conventional antenna sensors to receive the electromagnetic waves in some embodiments.

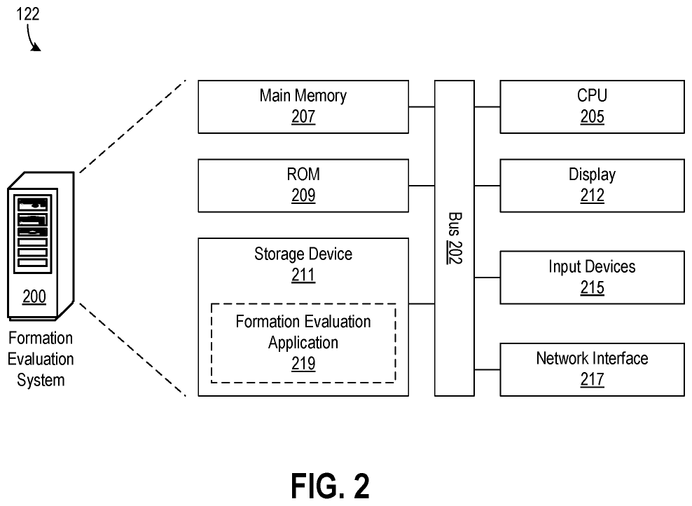

FIG. 2 illustrates an exemplary implementation of the formation evaluation system 122 according to the embodiments disclosed herein. The formation evaluation system 122, which is depicted as a surface level system (see FIGS. 1A and 1B) for ease of reference, may include a conventional computing system, such as a workstation, desktop, or laptop computer, indicated at 200, or it may include a custom computing system developed for a particular application. In a typical arrangement, the computing system 200 includes a bus 202 or other communication pathway for transferring information among other components within the computing system 200, and a CPU 204 coupled with the bus 202 for processing the information. The computing system 200 may also include a main memory 206, such as a random access memory (RAM) or other dynamic storage device coupled to the bus 202 for storing computer-readable instructions to be executed by the CPU 204. The main memory 206 may also be used for storing temporary variables or other intermediate information during execution of the instructions by the CPU 204.

The computing system 200 may further include a read-only memory (ROM) 208 or other static storage device coupled to the bus 202 for storing static information and instructions for the CPU 204. A computer-readable storage device 210, such as a nonvolatile memory (e.g., Flash memory) or magnetic disk drive, may be coupled to the bus 202 for storing information and instructions for the CPU 204. The CPU 204 may also be coupled via the bus 202 to a display 212 for displaying information to a user. One or more input devices 214, including alphanumeric and other keyboards, mouse, trackball, cursor direction keys, and so forth, may be coupled to the bus 202 for transferring information and command selections to the CPU 204. A communications interface 216 may be provided for allowing the computing system 200 to communicate with an external system or network.

The term “computer-readable instructions” as used above refers to any instructions that may be performed by the CPU 204 and/or other components. Similarly, the term “computer-readable medium” refers to any storage medium that may be used to store the computer-readable instructions. Such a medium may take many forms, including, but not limited to, non-volatile media, volatile media, and transmission media. Non-volatile media may include, for example, optical or magnetic disks, such as the storage device 210. Volatile media may include dynamic memory, such as main memory 206. Transmission media may include coaxial cables, copper wire and fiber optics, including the wires of the bus 202. Transmission itself may take the form of electromagnetic, acoustic or light waves, such as those generated for radio frequency (RF) and infrared (IR) data communications. Common forms of computer-readable media may include, for example, magnetic medium, optical medium, memory chip, and any other medium from which a computer can read.

A formation resistivity evaluation application 218, or the computer-readable instructions therefor, may also reside on or be downloaded to the storage device 210 for execution. The formation resistivity evaluation application 218 may be a standalone tool or it may be part of a larger suite of tools that may be used to obtain an overall evaluation of the formation 116. This evaluation application 218 may be implemented in any suitable computer programming language or software development package known to those having ordinary skill in the art, including various versions of C, C++, FORTRAN, and the like. Users may then use the evaluation application 218 to analyze the data from the one or more TWTW antenna sensors 118 to estimate resistivity, permittivity, and other formation properties.

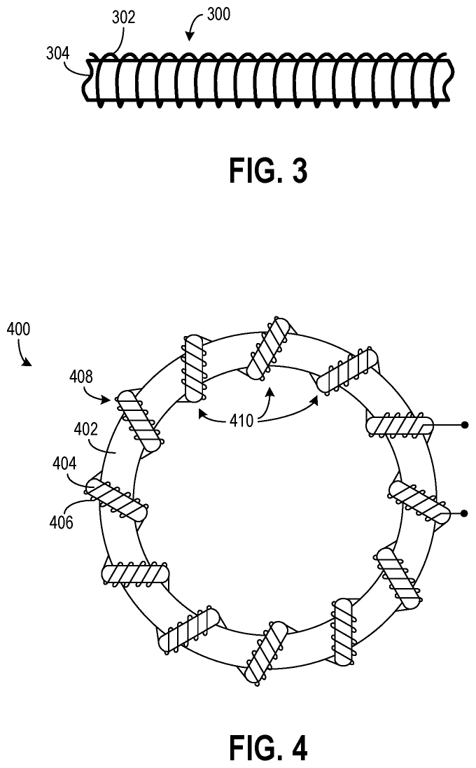

Referring now to FIG. 3, a toroidally-wound electrical conductor 300 is shown that may be used in the one or more TWTW antenna sensors 118 according some embodiments. The toroidally-wound electrical conductor 300 is composed mainly of a wire 302 or similar electrical conductor that is wound in a helical or spiral pattern around a core 304. The core 304 may simply be an air core, but is typically made of a ferromagnetic material, such as iron, steel, cobalt, nickel, and the like, and is usually insulated from the wire or electrical conductor 302. The toroidally-wound electrical conductor 300 (and the core 304 therein) may then be formed into a toroidally-wound toroidal winding similar to the one shown in FIG. 4 by winding the electrical conductor 300 in a helical pattern around a toroid shaped core.

FIG. 4 shows an exemplary TWTW antenna 400 that may be constructed from a toroidally-wound electrical conductor (see FIG. 3) according to the disclosed embodiments. As can be seen, the antenna 400 is composed of a primary core 402 in the shape of a toroid and a secondary core 404 wound in a helical or spiral pattern around the primary core 402. A wire 406 or similar electrical conductor is wound in a helical or spiral pattern around the secondary core 404, forming a toroidally-wound electrical conductor 408 that is structurally and electrically similar to the toroidally-wound electrical conductor 300 of FIG. 3. This toroidally-wound electrical conductor 408 also follows the path of the secondary core 404 around the primary core 402, thus forming a toroidally-wound toroidal winding, indicated generally at 410, around the primary core 402. The thusly constructed TWTW antenna 400 may then be used as or in the sensor 118 (i.e., as a receiver antenna) in accordance with the disclosed embodiments.

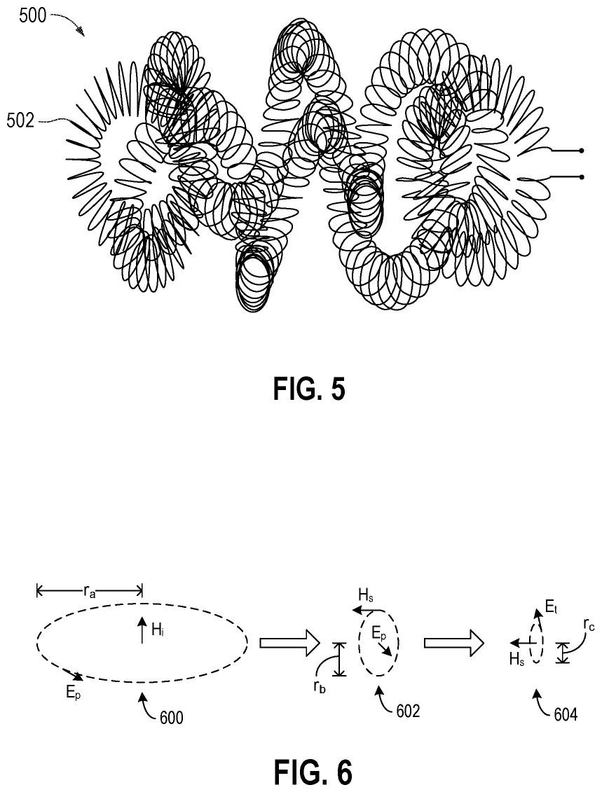

The primary core 402 is typically made of a ferromagnetic material, such as iron, steel, cobalt, nickel, and the like, and is normally insulated from the toroidally-wound electrical conductor 408, which may itself be a copper wire, for example. The secondary core 404 is also typically made of a ferromagnetic material, such as iron, steel, cobalt, nickel, and the like, and is also normally insulated from the toroidally-wound electrical conductor 406. The material used for the primary core 402, secondary core 404, and electrical conductor 406, as well as any insulating material, should be carefully selected to allow the antenna 400 to withstand harsh downhole environmental conditions, including high temperatures and pressures. It is of course possible in some embodiments for either the primary core 402 or the secondary core 404, or both, to be air cores (see FIG. 5) as needed depending on the particular application.

FIG. 5 depicts an alternative TWTW antenna 500 where the toroidally-wound toroidal winding itself is the TWTW antenna 500. In this embodiment, both the primary core and the secondary core may be air cores such that the TWTW antenna 500 is composed only (or primarily) of a toroidally-wound electrical conductor 502 wound in a helical or spiral pattern to form the toroidally-wound toroidal winding 500.

Operation of the TWTW antenna as a receiver may be described with reference to FIG. 6 and the well-known Maxwell equations:

$$\begin{matrix}∇ \cdot D = ρ & ( 1 ) \\ ∇ \cdot B = 0 & \\ ∇ \times E = - \frac{\partial B}{\partial t} & \\ ∇ \times H = \frac{\partial D}{\partial t} + J & \end{matrix}$$

where E is electric field, H is magnetic field, D is electric displacement field, B is magnetic flux density, ρ is free electric charge density, and J is free current density. In phasor form for a time harmonic field and assuming a simple medium with dielectric permittivity of E and magnetic permeability of μ, Maxwell's equations become:

$$∇ \cdot E = \frac{ρ}{ɛ} \\ ∇ \cdot H = 0 \\ ∇ \times E = - jw μ H \\ ∇ \times H = ( jw ɛ + σ ) E \qquad ( 2 )$$

In general, these equations explain that a magnetic field passing through the cross-section of a coil will induce an electric field in the circumferential direction on the coil. This electric field will generate an electromotive force that will in turn create a voltage difference in the coil that may be measured.

Referring to FIG. 6, the Maxwell equations may be applied to a TWTW antenna as follows. A TWTW antenna may be considered as comprising a primary turn 600 (i.e., the toroid core), secondary turns 602 (i.e., the secondary core), and tertiary turns 604 (i.e., the toroidally-wound electrical conductor). The primary turn 600 may have radius rₐ, the secondary turns 602 may have radius r_{b}, the tertiary turns 604 may have radius rₐ. An incident magnetic field Hᵢ passing through the cross-section of the primary turn 600 induces an electric field Eₚ in the primary turn. This electric field Eₚ induces a magnetic field Hₛ in the secondary turns 602, which creates an electric field Eₚ in the tertiary turns 604. The electric field Eₜ in the tertiary turns 604 creates a voltage on the tertiary turns equal to the integral of the electric field along the length of the turns.

As it can be seen from Equation (2), assuming a coil antennas source, the induced electric and magnetic fields for the primary turn 600 are proportional to the angular frequency co. However, the induced fields in the secondary turns 602 are proportional to ω², while the induced fields in the tertiary turns 604 are proportional to ω³. Thus, as co increases, the strength of a signal in a TWTW antenna may increase proportionately to ω³ compared to co for a conventional coil antenna (i.e., an improvement of ω²).

It should be understood, however, that the improved signal strength increase (i.e., improved receiver gain) may not be clearly noticeable at low frequencies. The reason is because the TWTW antenna is a combination of primary, secondary, and tertiary turns, and thus it can pick up the same signals that would normally be picked up by a conventional coil antenna. The signals received by the conventional coil antenna usually dominate at low frequencies (i.e., Earth fields) and will swamp the signals received by the tertiary turns at low frequencies. Once the frequency increases above a certain cutoff frequency where the signals received by the conventional coil antenna no longer dominate, then the improved receiver gain of the tertiary turns becomes more apparent. Simulations have shown in some instances that the improved receiver gain of the tertiary turns becomes apparent at about 10 MHz, with the highest receiver gains seen at about 1 GHz.

The improved signal strength increase as co increases allows the TWTW antenna to be used as a natural high-pass filter that can eliminate the effects of lower frequency noise, such as interference from tools working at lower frequencies, while strengthening higher frequency signals. This ability to suppress lower frequency noise and strengthen higher frequency signals makes the TWTW antenna particularly effective for use in sensors for dielectric logging applications and the like. Other downhole applications that may benefit from the TWTW antenna based sensors include short hop communication systems and fiber optic communication systems, such as those used for monitoring waterflood operations.

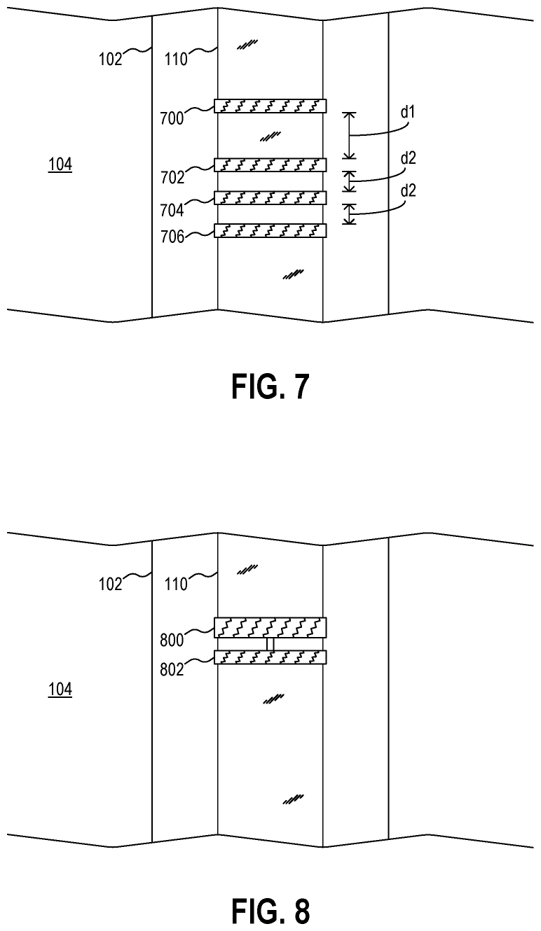

FIG. 7 illustrates an exemplary downhole application in which multiple TWTW antennas 700, 702, 704, and 706 may be used in a multi-axial configuration. In this application, the TWTW antennas 700-706 are coaxially mounted along the axis of a downhole tool 116 (e.g., on a mandrel thereof) within a wellbore 102 in a subterranean formation 104. The first TWTW antenna 700 operates as a transmitter while the remaining TWTW antennas 702-706 serve as receivers. As can be seen, the TWTW transmitter antenna 700 is spaced apart from the TWTW receiver antennas 702-706 by a distance “d1” that is greater than the distance “d2” by which the TWTW receiver antennas 702-706 are spaced apart from one another. In general, the spacing between a transmitter antenna and a receiver antenna, as well as the frequency of operation, determines the volume of investigation for any antenna pair. Thus, the spacing d1 between the TWTW transmitter antenna 700 and the TWTW receiver antennas 702-706 may be adjusted as needed to target a specific volume of interest. Information obtained from the multi-axial antenna configuration may then be used in an inversion process to obtain a radial and/or vertical permittivity profile of the formation in a manner known to those having ordinary skill in the art.

FIG. 8 illustrates another exemplary antenna configuration in which two TWTW receiver antennas 800 and 802 are coaxially mounted on the downhole tool 116 in a bucking configuration. This bucking configuration is useful when there is a strong direct coupling between a transmitter antenna and a receiver antenna. The direct coupling may overwhelm and/or distort any signals received by the receiver antenna from the formation 104, making it difficult to accurately determine the properties of the volume of interest. To counter such coupling, the TWTW antennas 800-802 may be arranged as a main antenna 800 and a bucking antenna 802 connected to the main TWTW antenna 800 so that the two antennas have opposite polarizations (i.e., wound in opposite directions). The precise position of the bucking antenna 802 relative to the main antenna 800 and the number of turns of the bucking antenna 802 may be adjusted such that the bucking antenna cancels any direct coupling on the main antenna 800 by the transmitter (not expressly shown). This ensures that any signals picked up by the main antenna 800, to a very good approximation, do not contain any direct field contribution from the transmitter antenna.

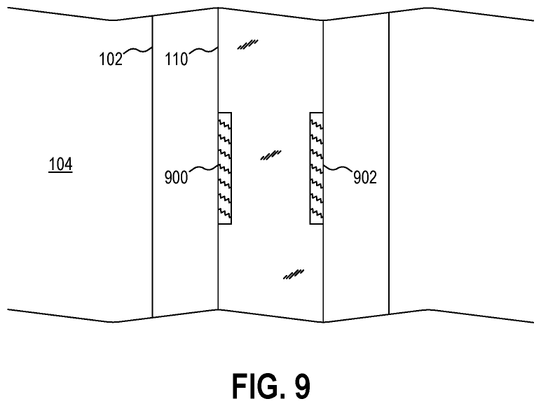

FIG. 9 illustrates yet another exemplary antenna configuration in which two TWTW antennas 900 and 902 may be used to approximate a gradient (i.e., spatial derivative) of an electromagnetic field (or voltage which is proportional to the field). The information obtained from the gradient may be used to obtain a radial gradient of the voltage signal, which is useful in a variety of applications, including ranging operations. In FIG. 9, the two TWTW antennas 900 and 902 are located along radially opposite sides of the tool 116. By subtracting the voltages measured by the radially opposing antennas 900 and 902 and dividing by the distance between them, the gradient of the measurement in the radial direction may be obtained. This is mathematically shown in Equation 3 below, where the component of the gradient of the voltage (V) in the radial direction (i) may be approximated by taking the difference in the voltages measured by antenna 1 (i.e., antenna 900) and antenna 2 (i.e., antenna 902), divided by the radial distance between them.

$$∇ V \cdot \vec{r} \approx \frac{{V}_{1} - {V}_{2}}{Δ r} \qquad ( 3 )$$

In a similar manner, although not expressly depicted, a gradient in the axial direction may also be obtained by coaxially mounting two TWTW antennas on a downhole tool. This configuration resembles the bucking configuration from FIG. 8 except that the purpose of the second TWTW antenna is not to cancel the direct field contribution of a transmitter antenna, but rather to measure the rate of change of the measured electromagnetic field with respect to axial distance. This information may then be used to obtain an axial or vertical gradient of the voltage signal.

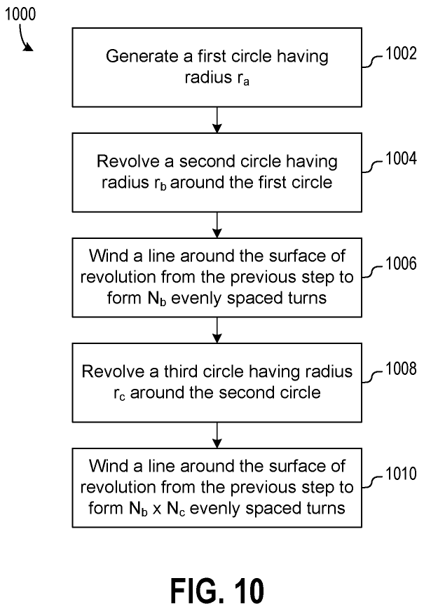

FIG. 10 illustrates an exemplary method 1000 that may be used to design a TWTW antenna for the foregoing downhole applications. The method 1000 allows the TWTW antenna to have any suitable size and gain characteristic needed for a particular application. The main parameters used to design the TWTW antenna are the primary turn radius rₐ, the secondary turn radius r_{b}, the tertiary turn radius r_{c}, the number Nb of secondary turns, and the number N_{c} of tertiary turns in a single secondary turn (see FIG. 6). As an example, a typical TWTW antenna that may be used with a conventional downhole tool may have a primary turn radius rₐ of about 2.5 inches, secondary turn radius r_{b} of about 0.75 inches, tertiary turn radius r_{c} of about 0.25 inches, secondary turn number Nb of about 9 turns, and tertiary turn number N_{c} of about 42 turns in a single secondary turn.

As can be seen in FIG. 10, designing a TWTW antenna begins in some embodiments by generating a first circle having radius rₐ at block 1002. A second circle having radius r_{b} is revolved around the first circle at block 1004. Then, a line (wire) is wound around the surface of revolution from the block 1004 to form Nb evenly spaced turns at block 1006. Thereafter, a third circle having radius r_{c} is revolved around the second circle at block 1008. And last but not least, a line is wound around the surface of revolution from block 1008 to form N_{b}×N_{c} evenly spaced turns at block 1010. Note that while the method 1000 of FIG. 10 is shown using a number of discrete blocks, those having ordinary skill in the art will understand that any individual block may be divided into two or more constituent blocks, and that any two or more blocks may be combined to form a superblock, without departing from the scope of the disclosed embodiments.

Any individual turn of a TWTW antenna designed as set forth above may be described mathematically by Equations (4)-(7) below, where x, y and z are the set of points that describe the TWTW antenna:

x1=ra×cos(Φ)

y1=ra×sin(Φ)

z1=0 (4)

x2=rb×cos(1×N_{b})×cos(Φ)

y2=rb×cos(b×N_{b})×sin(Φ)

z2=rb×sin(Φ×N_{b}) (5)

x3=rc×cos(Φ×Nc×N_{b})×cos(Φ×N_{b})×cos(Φ)−rc×sin(Φ×Nc×N_{b})×sin(Φ)

y3=rc×cos(Φ×Nc×N_{b})×cos(Φ×N_{b})×sin(Φ)+rc×sin(Φ×Nc×N_{b})×cos(Φ)

z3=rc×cos(Φ×Nc×N_{b})×sin(Φ×N_{b}) (6)

x=x1+x2+x3

y=y1+y2+y3

z=z1+z2+z3 (7)

In the above equations, ϕ is a radial angle between 0 and 360 degrees, N_{b} is the number of turns of the toroidal windings (i.e., secondary turns); N_{c} is the number of turns in the toroidal windings (i.e., tertiary turns); r_{b} is the radius of the winding of the toroidal windings; r_{c} is the radius of the toroidal windings; rₐ is the radius of the overall TWTW antenna; x1, y1 and z1 are displacements of the main (single) loop in the X, Y and Z Cartesian directions, respectively; x2, y2 and z2 are displacements of the winding of the toroidal windings in the X, Y and Z Cartesian directions, respectively; and x3, y3 and z3 are displacements of the toroidal windings in the X, Y and Z Cartesian directions, respectively. The Equations (4)-(7) thus allow each point on the TWTW antenna to be defined in the Cartesian coordinate system.

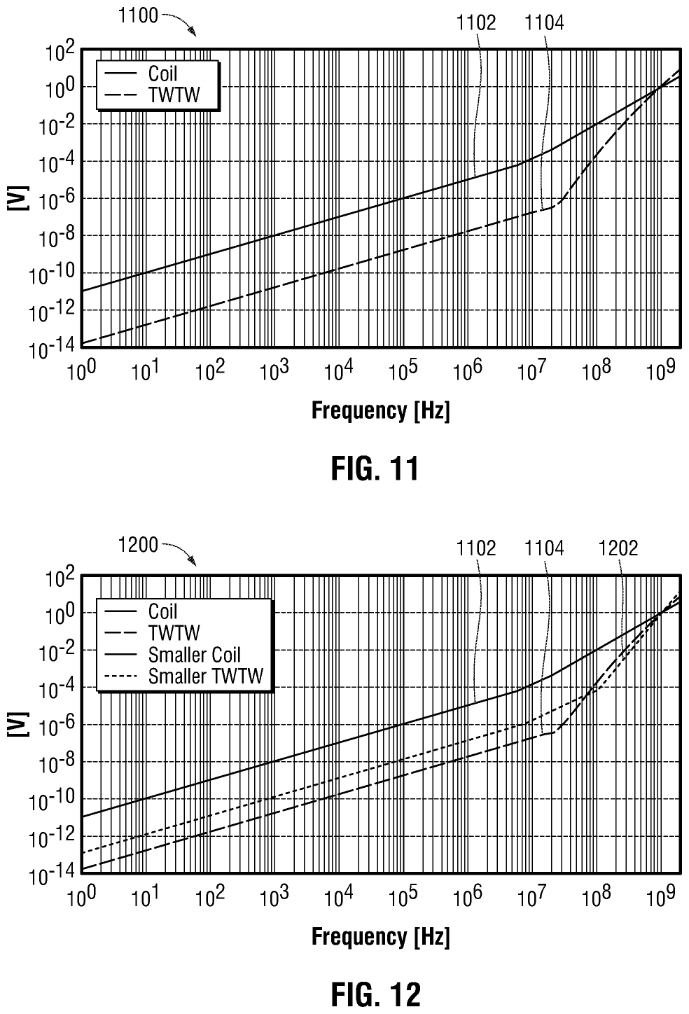

To demonstrate the behavior of the TWTW antenna, a simulation was performed and the results are displayed in FIG. 11 for an exemplary TWTW antenna. In FIG. 11, a chart 1100 is shown in which the vertical axis represents measured voltage, the horizontal axis represents frequency (Hz), line 1102 represents voltage measured by a conventional coil receiver antenna, and line 1104 represents voltage measured by a TWTW receiver antenna. The simulation was performed using conventional coil transmitter coaxially mounted about 200 inches from the TWTW receiver antenna and assuming a vacuum medium. The radius of both the coil transmitter and the primary turn of the TWTW antenna (rₐ) is 10 inches, the radius of the secondary turns (r_{b}) is 4 inches, the number of secondary turns (N_{b}) is 16, the radius of tertiary turns (r_{c}) is 1.75 inches, and the number of tertiary turns (N_{c}) is 1024. The simulation also assumed that magnetic moment vector of the coil transmitter and the primary turn of the TWTW antenna are aligned. Receiver gain was normalized to 1 at a frequency of 1 GHz.

As FIG. 11 shows, the voltage measured by the coil antenna (line 1102) is proportional to the frequency until around 10 MHz, at which point it becomes proportional to the square of the frequency (i.e., the ω² term becomes dominant). The TWTW antenna shows a similar behavior until around 30 MHz when the ω³ term starts to become dominant for the TWTW antenna. Importantly, it can be seen that the TWTW antenna has about the same gain as the coil antenna up to 1 GHz, but is able to suppress lower frequencies (e.g., up to 10 MHz) about 700 times (or more) better than the coil antenna.

In the simulation of FIG. 11, the main factor affecting the gain of the TWTW receiver antenna is the size of the antenna. Thus, the gain of the antenna may be adjusted by changing one or more of the radii of the antenna, for example the radius r_{c} of the tertiary turns (i.e., toroidally-wound electrical conductor), or the radius r_{b} of the secondary turns (i.e., toroidally-wound toroidal winding). The effect on antenna gain from the changes to the one or more of the radii can be seen in FIG. 12, which shows the result of a simulation performed for a TWTW antenna with dimensions that are 4 times smaller.

In FIG. 12, a chart 1200 is shown that is otherwise the same as the chart 1100 from FIG. 11 line, except a line 1202 has been added representing voltage measured by a TWTW receiver antenna dimensions that are 4 times smaller. Specifically, the TWTW antenna represented by line 1202 has a primary turn radius (rₐ) of 2.5 inches, a secondary turn radius (r_{b}) of 1 inch, and a tertiary turn radius (r_{c}) of 0.4375 inches. The secondary turn number (N_{b}) and the tertiary turn number (N_{c}) are the same as in the previous simulation (i.e., N_{b}=16, N_{c}=1024).

As FIG. 12 shows, the gain of the conventional coil antenna (line 1102) is unchanged from the previous simulation when normalized at 1 GHz. Similarly, the smaller TWTW antenna (line 1202) behaves like the conventional coil antenna up to around 100 MHz when the ω³ term starts to become dominant for the TWTW antenna. However, the ability of the smaller TWTW antenna (line 1202) to suppress low frequencies (e.g., up to 10 MHz) is almost 10 times worse compared to the larger TWTW antenna (line 1104).

As can be deduced from the above simulations (and from Equation (2)), electromagnetic sensors working at low frequencies are primarily sensitive to the resistivity of the medium. However, as the frequency of operation increases, the contribution from the higher frequencies, which also relates to the dielectric permittivity, becomes more dominant. The operational frequencies of downhole tools used to measure dielectric permittivity are in the order of gigahertz. Moreover, during logging, many different tools may be stacked together. These tools generally have different frequencies of operation and different sensitivity regions. However, interference between the tools remain an area of concern. Electronic circuitry to prevent such interference by filtering frequency components out of the tool's band of operation are often needed. The TWTW antenna disclosed herein may naturally perform some of the interference filtering for dielectric logging applications. As described above (see FIGS. 11 and 12), sensors that are based on the TWTW antenna disclosed herein may provide filtering in the order of hundreds of times better compared to a traditional coil antenna. Thus, such an antenna would reduce the need for additional filtering, simplifying design and reducing cost.

The TWTW antenna disclosed herein may also be advantageously employed in short hop communication systems. Communication is the transfer of information and it is generally understood that a higher rate of information may be transferred at higher frequencies. Thus, the disclosed TWTW antenna may also be useful in transmitting and receiving data for high-frequency communication systems while again eliminating interference. At higher frequencies, signals attenuate faster, which suggest that short hop communication systems where transmit-receive spacing is low would be most likely to benefit from the TWTW antenna disclosed herein.

And as mentioned above, waterflood monitoring applications would also benefit from using TWTW antenna-based sensors. In waterflood monitoring, water is injected from one well to increase the production in a separate production well. Permanent sensors based on TWTW antennas in the production well may be used to estimate the position of the water. This information may in turn be used to optimize the water injection and maximize production. Fiber optic lines are generally used to transmit information from the sensors to the surface in these applications. Several such sensors at different frequencies may operate at the same time to increase information about the waterflood in these systems.

Accordingly, as set forth above, the embodiments disclosed herein may be implemented in a number of ways. For example, in general, in one aspect, the disclosed embodiments may relate to an antenna for a downhole logging tool. The antenna may comprise, among other things, a toroid core mountable on the downhole logging tool and a toroidally-wound electrical conductor wound around the toroid core in a helical pattern, thereby forming a toroidally-wound toroidal winding, the toroidally-wound toroidal winding having a predetermined number of turns around the toroid core. The antenna may further comprise an insulating material disposed between the toroidally-wound toroidal winding and the toroid core, the insulating material electrically insulating the toroidally-wound toroidal winding from the toroid core. The insulating material, the toroidally-wound toroidal winding, and the toroid core are composed of materials that allow the antenna to operate under downhole environmental conditions.

In accordance with any one or more of the foregoing embodiments, the antenna is operated as one of: a transmitter antenna, or a receiver antenna.

In accordance with any one or more of the foregoing embodiments, the antenna is operated as both a transmitter antenna and a receiver antenna.

In accordance with any one or more of the foregoing embodiments, the toroid core is one of: a ferromagnetic core, a wire mesh core, or an air core.

In accordance with any one or more of the foregoing embodiments, the toroidally-wound electrical conductor has one of: a ferromagnetic core, a wire mesh core, or an air core.

In accordance with any one or more of the foregoing embodiments, the antenna allows frequencies higher than a cutoff frequency to pass and suppresses frequencies lower than the cutoff frequency, the cutoff frequency being between about 10 MHz and about 1 GHz.

In general, in another aspect, the disclosed embodiments may relate to a method of sensing an electromagnetic signal in a downhole logging tool. The method comprises, among other things, receiving the electromagnetic signal at an antenna mounted on the downhole logging tool, the electromagnetic signal inducing a voltage signal having multiple frequency components in the antenna. The antenna comprises a toroid core and a toroidally-wound electrical conductor wound around the toroid core in a helical pattern, thereby forming a toroidally-wound toroidal winding, the toroidally-wound toroidal winding having a predetermined number of turns around the toroid core. The method further comprises allowing certain frequency components of the voltage signal to pass through the antenna and logging the voltage signal that is outputted by the antenna using the logging tool.

In accordance with any one or more of the foregoing embodiments, allowing certain frequency components of the voltage signal to pass through the antenna comprises allowing frequency components higher than a cutoff frequency to pass, the cutoff frequency being between about 10 MHz and about 1 GHz.

In accordance with any one or more of the foregoing embodiments, allowing certain frequency components of the voltage signal to pass through the antenna further comprises suppressing frequency components lower than the cutoff frequency.

In accordance with any one or more of the foregoing embodiments, the method further comprises adjusting the cutoff frequency of the antenna by changing one or more of: a radius of the toroidally-wound electrical conductor, or a radius of the toroidally-wound toroidal winding.

In general, in yet another aspect, the disclosed embodiments may relate to a downhole logging tool for determining a property of a subterranean formation. The downhole logging tool comprises, among other things, a tool body and at least one toroidally-wound toroidal winding antenna mounted on the tool body. The at least one toroidally-wound toroidal winding antenna comprises a toroid core and a toroidally-wound electrical conductor wound around the toroid core in a helical pattern to form a toroidally-wound toroidal winding, the toroidally-wound toroidal winding having a predetermined number of turns around the toroid core. The downhole logging tool further comprises a signal processing unit connected to the at least one toroidally-wound toroidal winding antenna, the signal processing unit operable to log a voltage signal outputted by the at least one toroidally-wound toroidal winding antenna.

In accordance with any one or more of the foregoing embodiments, the at least one toroidally-wound toroidal winding antenna comprises multiple toroidally-wound toroidal winding antennas coaxially mounted on the tool body and having a predefined spacing therebetween.

In accordance with any one or more of the foregoing embodiments, the predefined spacing is selected based on a volume of interest in the subterranean formation.

In accordance with any one or more of the foregoing embodiments, the voltage signal outputted by the multiple toroidally-wound toroidal winding antennas contains information that may be used to obtain one of: a radial permittivity profile for the volume of interest, or vertical permittivity profile for the volume of interest.

In accordance with any one or more of the foregoing embodiments, the voltage signal outputted by the coaxially mounted multiple toroidally-wound toroidal winding antennas contains information that may be used to obtain an axial gradient of the voltage signal.

In accordance with any one or more of the foregoing embodiments, the multiple toroidally-wound toroidal winding antennas coaxially mounted on the tool body are arranged in a bucking configuration in which the toroidally-wound electrical conductor of one antenna is wound around the toroid core of said antenna in a direction opposite from the toroidally-wound electrical conductor of a second antenna.

In accordance with any one or more of the foregoing embodiments, the voltage signal outputted by the radially mounted multiple toroidally-wound toroidal winding antennas contains information that may be used to obtain a radial gradient of the voltage signal.

In accordance with any one or more of the foregoing embodiments, the tool body comprises a mandrel of the logging tool.

While the invention has been described with reference to one or more particular embodiments, those skilled in the art will recognize that many changes may be made thereto without departing from the spirit and scope of the description. Each of these embodiments and obvious variations thereof is contemplated as falling within the spirit and scope of the claimed invention, which is set forth in the following claims.

1. An antenna for a downhole logging tool, comprising:
a toroid core mountable on the downhole logging tool; and
a toroidally-wound electrical conductor wound around the toroid core in a helical pattern, thereby forming a toroidally-wound toroidal winding, the toroidally-wound toroidal winding having a predetermined number of turns around the toroid core; and
an insulating material disposed between the toroidally-wound toroidal winding and the toroid core, the insulating material electrically insulating the toroidally-wound toroidal winding from the toroid core;
wherein the insulating material, the toroidally-wound toroidal winding, and the toroid core are composed of materials that allow the antenna to operate under downhole environmental conditions.

2. The antenna of claim 1, wherein the antenna is operated as one of: a transmitter antenna, or a receiver antenna.

3. The antenna of claim 1, wherein the antenna is operated as both a transmitter antenna and a receiver antenna.

4. The antenna of claim 1, wherein the toroid core is one of: a ferromagnetic core, a wire mesh core, or an air core.

5. The antenna of claim 4, wherein the toroidally-wound electrical conductor has one of: a ferromagnetic core, a wire mesh core, or an air core.

6. The antenna of claim 1, wherein the antenna allows frequencies higher than a cutoff frequency to pass and suppresses frequencies lower than the cutoff frequency, the cutoff frequency being between about 10 MHz and about 1 GHz.

7. A method of sensing an electromagnetic signal in a downhole logging tool, comprising:
receiving the electromagnetic signal at an antenna mounted on the downhole logging tool, the electromagnetic signal inducing a voltage signal having multiple frequency components in the antenna, the antenna comprising a toroid core and a toroidally-wound electrical conductor wound around the toroid core in a helical pattern to form a toroidally-wound toroidal winding, the toroidally-wound toroidal winding having a predetermined number of turns around the toroid core;
allowing certain frequency components of the voltage signal to pass through the antenna; and
logging the voltage signal that is outputted by the antenna using the logging tool.

8. The method of claim 7, wherein allowing certain frequency components of the voltage signal to pass through the antenna comprises allowing frequency components higher than a cutoff frequency to pass, the cutoff frequency being between about 10 MHz and about 1 GHz.

9. The method of claim 8, wherein allowing certain frequency components of the voltage signal to pass through the antenna further comprises suppressing frequency components lower than the cutoff frequency.

10. The method of claim 9, further comprising adjusting the cutoff frequency of the antenna by changing one or more of: a radius of the toroidally-wound electrical conductor, or a radius of the toroidally-wound toroidal winding.

11. A downhole logging tool for determining a property of a subterranean formation, comprising:
a tool body;
at least one toroidally-wound toroidal winding antenna mounted on the tool body, the at least one toroidally-wound toroidal winding antenna comprising a toroid core and a toroidally-wound electrical conductor wound around the toroid core in a helical pattern to form a toroidally-wound toroidal winding, the toroidally-wound toroidal winding having a predetermined number of turns around the toroid core; and
a signal processing unit connected to the at least one toroidally-wound toroidal winding antenna, the signal processing unit operable to log a voltage signal outputted by the at least one toroidally-wound toroidal winding antenna.

12. The downhole logging tool of claim 11, wherein the at least one toroidally-wound toroidal winding antenna comprises multiple toroidally-wound toroidal winding antennas coaxially mounted on the tool body and having a predefined spacing therebetween.

13. The downhole logging tool of claim 12, wherein the predefined spacing is selected based on a volume of interest in the subterranean formation.

14. The downhole logging tool of claim 13, wherein the voltage signal outputted by the multiple toroidally-wound toroidal winding antennas contains information that may be used to obtain one of: a radial permittivity profile for the volume of interest, or vertical permittivity profile for the volume of interest.

15. The downhole logging tool of claim 13, wherein the voltage signal outputted by the coaxially mounted multiple toroidally-wound toroidal winding antennas contains information that may be used to obtain an axial gradient of the voltage signal.

16. The downhole logging tool of claim 12, wherein the multiple toroidally-wound toroidal winding antennas coaxially mounted on the tool body are arranged in a bucking configuration in which the toroidally-wound electrical conductor of one antenna is wound around the toroid core of said antenna in a direction opposite from the toroidally-wound electrical conductor of a second antenna.

17. The downhole logging tool of claim 12, wherein the voltage signal outputted by the radially mounted multiple toroidally-wound toroidal winding antennas contains information that may be used to obtain a radial gradient of the voltage signal.

18. The downhole logging tool of claim 11, wherein the tool body comprises a mandrel of the logging tool.
